(19) United States
(12) Patent Application Publication
(10) Pub. No.: US 2011/0109558 A1
(43) Pub. Date: May 12, 2011

(54) BUTTON EXTENSION TYPE LETTER INPUT SYSTEM FOR TOUCH SCREEN

(75) Inventor: Byung-Jin Park, Gimcheon-si (KR)

(73) Assignee: Samsung Electronics Co., Ltd., Suwon-city, Gyeonggi-do (KR)

(21) Appl. No.: 12/935,763

(22) PCT Filed: Mar. 27, 2009
(86) PCT No.: PCT/KR2009/001583

§ 371 Date: Nov. 29, 2010

(30) Foreign Application Priority Data
Mar. 31, 2008 (KR) 10-2008-0029420

(51) Int. Cl. G06F 3/02

(52) U.S. Cl. 345/171; 345/168

(57) ABSTRACT

A method for inputting key-extension letters is provided. The method is adapted to a touch screen installed to a mobile device or a stationary communication device. The method includes: (1) allocating representative letters to 12 keys, including the number, * and # keys, or to a corresponding number of keys, respectively; (2) arranging, if one of the keys is pressed, keys to which numbers, consonants, vowels, letters, or symbols are allocated, around the pressed key, wherein the numbers, consonants, vowels, letters, or symbols (hereinafter called ‘first related letters’) are related to a representative letter assigned to the pressed key; (3) inputting, when an object (a user' s finger, etc.) moves from the pressed key to other keys to which the first related letters are assigned without losing the contact of the pressed key and then releases the pressing operation from the pressed key or a corresponding key, the representative letter or one of the first related letters assigned to the corresponding key to the touch screen; and (4) arranging, when the key to which one of the first related letters is assigned is pressed, keys to which second related letters, related to a first related letter assigned to the pressed first related-letter key, are assigned, around the first related letter key.

### BACKGROUND OF THE INVENTION

1. Field of the Invention

This invention relates to touch screens, and more particularly, to a method for inputting key-extension letters on a touch screen that can repeatedly generate, when a particular key is pressed, keys related to a corresponding key and can input, when a pressing operation is released from the generated key, a letter at a corresponding position, when letters, such as Hangeul (i.e., Korean letters), are input on a touch screen of a mobile device (e.g. mobile phone, navigation system, PDA, PMP, etc.) or a stationary communication device. This invention resolves the conventional problems where a collision occurs when consonants are input on the touch screen or letters are input by complicatedly combining consonants and vowels. This invention also allows users to easily and rapidly input Hangeul, English, Japanese, etc. as well as numbers, symbols, etc., by using the minimum number of keys or pressing the keys the minimum number of times.

2. Description of the Related Art

There are a variety of methods for inputting the Korean alphabet, i . e . , Hangeul (the written form of the Korean language), to mobile devices and stationary devices. Such conventional Hangeul input methods have been developed to be adapted to a key type keyboard or keypad. They can also be applied to a touch screen.

Of the conventional Hangeul input methods, more than 80% of mobile devices employ “Cheon-Ji-In” and “EZ Hangeul.” These two methods dominate the market.

The “Cheon-Ji-In” input method incorporates cultural elements to assist the user in adopting the technology. Cheon, Ji, and In have the meaning of sky, ground and person, respectively, which are represented by the symbols [symbol] and [symbol] respectively. As shown in FIG. 1, the Cheon Ji In symbols are assigned to the keys 1, 2 and 3 at the upper three keys of the keypad, and all vowels are constructed using these symbols. The seven groups of consonants, [symbol] , [symbol] , [symbol] [symbol] , [symbol] , [symbol] , and [symbol] are assigned to the rest of the keys, respectively, and are produced by a user's multi-operations. In order to input a Korean syllable, it requires more key strokes corresponding to vowel or consonant keys.

However, Cheon-Ji-In has the following disadvantages.

First, when vowels are input, three keys corresponding to the symbols [symbol] and [symbol] must be sequentially operated according to the number of strokes of other basic and compound vowels. This requires a number of user's key operations corresponding to the number of strokes, thereby reducing the letter input efficiency. For example, compound vowels, [symbol] [symbol] etc., require 4-5 key operations. Since Korean syllables are configured in such a way that each syllable has one vowel, the low efficiency of the vowel input decreases the total input efficiency of Korean syllables.

Secondly, when consonants are input, since 19 consonants are assigned to 7 keys by 2-3 consonants, other consonants, assigned to the same key, can be searched for and used to form a syllable as the same key is consecutively operated. Inparticular, when a consonant at the initial position of a syllable is input where the consonant is the same as the final position of a previous syllable or is the second or third consonant in the same key to which the key is assigned, a consonant collision phenomenon occurs. In that case, the user can input the next letter after waiting two seconds until the cursor moves to a position in order to receive the next input or after he/she operates a cursor movement key. As described above, the complicated vowel input method and the consonant colli sion phenomenon decrease the input efficiency of Hangeul for Cheon-Ji-In.

The “EZ Hangeul” input method serves to add a stroke and double a consonant to compose the syllables. In order to implement the EZ Hangeul input method, the arrangement of the keys is configured, as shown in FIG. 2, in such away that: six consonants, [symbol] [symbol] and [symbol] are assigned to the number keys, 1, 2, 4, 5, 7, and 8, respectively; some vowels, [symbol] [symbol] and [symbol] are assigned to the number keys 3, 6, 9, and 0, respectively; the * key is set to perform ‘adding a stroke’; and the # key is set to perform ‘doubling a consonant.’ In order to input a syllable, the keys corresponding to consonants are used with the keys ‘*’ and ‘#’ to form the remaining consonants and vowels.

Although EZ Hangeul resolves the problems in Cheon-Ji-In, i.e., the complicated vowel input method and the consonant collision phenomenon, it has the following disadvantages.

When consonants are input, since only six consonants of the 19 consonants in Hangeul, [symbol] [symbol] and [symbol] are assigned to the number keys, 1, 2, 4, 5, 7, and 8, other consonants, [symbol] and [symbol] for example, can be input to the mobile device in such a way that the keys, [symbol] [symbol] and [symbol] are operated and then the key ‘* (add a stroke)’ is also operated, so that they can be converted to [symbol] [symbol] and [symbol] and thus input thereto. Likewise, other consonants, [symbol] and [symbol] for example, can be input to the mobile device in such a way that: the keys, [symbol] and [symbol] are operated; the key ‘* (add a stroke)’ is operated, so that they can be converted to [symbol] and [symbol] ; and then the key ‘* (add a stroke)’ is again operated, so that they can be converted to [symbol] and [symbol] and thus input thereto. In addition, other consonants, [symbol] and [symbol] for example, can be input to the mobile device in such a way that: the keys, [symbol] and [symbol] are operated; the key ‘* (add a stroke)’ is operated, so that they can be converted to [symbol] and [symbol] ; and then the key ‘# (double a consonant)’ is operated, so that they can be converted to [symbol] and [symbol] and thus input thereto. As described above, the EZ Hangeul input method inputs consonants via complicated processes, thereby reducing the entire input efficiency of Korean syllables.

When other vowels, [symbol] or [symbol] , for example, not shown on the keys, are input, the keys, [symbol] and [symbol] are first operated and the key ‘* (add a stroke)’ is then operated. Therefore, the EZ Hangeul input method also inputs vowels via complicated processes, thereby reducing the entire input efficiency of Korean syllables.

In addition, conventional letter input methods can allow for the input of other letters, in English. However, they are still disadvantageous in that it has very low input efficiency. Since the 26 letters of the English alphabet are assigned to 8-9 keys by 3-4 letters, an input delay phenomenon like the consonant collision phenomenon of Cheon-Ji-In occurs when English letters are input. That is, when the user consecutively inputs the same letter or another letters assigned to the same key, he/she can only input the next letter after a certain period of time has elapsed until the cursor moves to a position in order to receive the next letter or after he/she operates a cursor movement key.

Conventional letter input methods can also allow for the input of numbers. However, when the user inputs other symbols, for example, -, [symbol] , (,), etc. , he/she must switch the input modes each time. Therefore, conventional letter input methods have very low input efficiency when letters, Korean, English, etc., numbers, symbols, etc.

### SUMMARY OF THE INVENTION

The invention solves the above problems, and provides a method for inputting key-extension letters on a touch screen that can repeatedly generate, when a particular key is pressed, keys related to a corresponding key and can input, when a pressing operation is released from the generated key, a letter at a corresponding position, when letters, such as Hangeul (i.e., Korean alphabet), are input on a touch screen of a mobile device (e.g. mobile phone, navigation system, PDA, PMP, etc.) or a stationary communication device. Therefore, the letter input method can resolve the conventional problems where a collision phenomenon occurs when consonants are input on the touch screen or letters are complicatedly input by combining consonants and vowels. The letter input method can also allow users to easily and rapidly input Hangeul, English, Japanese, etc. as well as numbers, symbols, etc., by using the minimum number of keys or pressing the keys the minimum number of times.

In accordance with an exemplary embodiment of the invention, there is provided a method for inputting key-extension letters on a touch screen installed to a mobile device or a stationary communication device, the method including: (1) allocating representative letters to 12 keys, including the number, * and # keys, or to a corresponding number of keys, respectively; (2) arranging, if one of the keys is pressed, keys to which numbers, consonants, vowels, letters, or symbols are allocated, around the pressed key, wherein the numbers, consonants, vowels, letters, or symbols (hereinafter called ‘first related letters’) are related to a representative letter assigned to the pressed key; (3) inputting, when an object (a user's finger, etc.) moves from the pressed key to other keys to which the first related letters are assigned without losing the contact of the pressed key and then releases the pressing operation from the pressed key or a corresponding key, the representative letter or one of the first related letters assigned to the corresponding key to the touch screen; and (4) arranging, when the key to which one of the first related letters is assigned is pressed, keys to which second related letters, related to a first related letter assigned to the pressed first related-letter key, are assigned, around the first related letter key.

Preferably, in a Hangeul input mode, the method may further include: assigning 10 representative letters, [symbol] [symbol] and [symbol] [symbol] [symbol] to [symbol] number keys; arranging, when a key to which one of the representative letters is assigned is pressed, keys to which third related letters are assigned, around the pressed representative letter key, wherein the third related letters include the number assigned to the pressed key, voiced consonants of the representative letter assigned to the pressed key, and the vowels [symbol] and [symbol] arranging, when the object moves from the key, to which the representative letter is assigned, to the vowel [symbol] key, while pressing the key to which the representative letter is assigned, keys to which the vowels [symbol] and [symbol] related to the vowel [symbol] are assigned, around the vowel [symbol] key; arranging, when the object moves from the vowel [symbol] key to the vowel [symbol] or [symbol] key without losing the contact of the vowel [symbol] key, keys to which the vowels [symbol] and [symbol] related to the vowel [symbol] , assigned, around the vowel [symbol] key, or keys to which the vowels, [symbol] and [symbol] related to the vowel [symbol] , assigned, around the vowel [symbol] key; arranging, when the object moves from the key, to which the representative letter is assigned, to the vowel [symbol] key, while pressing the key to which the representative letter is assigned, keys to which the vowels, [symbol] and [symbol] related to the vowel [symbol] , are assigned, around the vowel [symbol] key; arranging, when the object moves from the vowel [symbol] key to the vowel [symbol] or [symbol] key without losing the contact of the vowel [symbol] key, keys to which the vowel [symbol] and [symbol] related to the vowel [symbol] are assigned, around the vowel [symbol] key, or keys, to which the vowels [symbol] [symbol] and [symbol] keys, related to the vowel [symbol] key, are assigned, around the vowel [symbol] key; and inputting, when the object moves from one key to another while pressing the key to which the representative letter and the third related letter are assigned, and then releases the pressing operation, a Korean syllable combined with corresponding consonants and vowels.

Preferably, themethodmay further include: arranging,when the object moves from a key, to which one of the representative letters is assigned, to the key to which the voiced consonant is assigned, while pressing the key to which the representative letter is assigned, keys to which fourth related letters are assigned, around the key to which the voiced consonant is assigned, wherein the fourth related letters include compound consonants related to the voiced consonant and the vowels [symbol] and [symbol] ; arranging, when the object moves from the key, to which the voiced consonant is assigned, to the vowel [symbol] key, while pressing the key to which the voiced consonant letter is assigned, keys to which the vowels [symbol] and [symbol] related to the vowel [symbol] are assigned, around the vowel [symbol] key; arranging, when the object moves from the vowel [symbol] key to the vowel [symbol] or [symbol] key without losing the contact of the vowel [symbol] key, keys to which the vowels, [symbol] [symbol] and [symbol] related to the vowel [symbol] , assigned, around the vowel [symbol] key, or keys to which the vowels, [symbol] and [symbol] related to the vowel [symbol] , assigned, around the vowel [symbol] key; arranging, when the object moves from the key, to which the voiced consonant is assigned, to the vowel [symbol] key, while pressing the key to which the voiced consonant is assigned, keys to which the vowels, [symbol] and [symbol] related to the vowel [symbol] , are assigned, around the vowel [symbol] key; arranging, when the object moves from the vowel [symbol] key to the vowel [symbol] or [symbol] key without losing the contact of the vowel [symbol] key, keys to which the vowel [symbol] [symbol] and [symbol] related to the vowel [symbol] are assigned, around the vowels [symbol] key, or keys, to which the vowels [symbol] [symbol] and [symbol] keys, related to the vowel [symbol] key, are assigned, around the vowel [symbol] key; and inputting, when the object moves from one key to another while pressing the key to which the representative letter and the fourth related letter are assigned, and then releases the pressing operation, a Korean syllable combined with corresponding consonants and vowels.

Preferably, the method may further include: arranging, when the object moves from a key, to which the voiced consonant is assigned, to the key to which the compound consonant is assigned, while pressing the key to which the voiced consonant is assigned, keys to which fifth related letters are assigned, around the key to which the compound consonant is assigned, wherein the fifth related letters include the vowels [symbol] and [symbol] related to the compound consonant; arranging, when the object moves from the key, to which the voiced consonant is assigned, to the vowel [symbol] key, while pressing the key to which the voiced consonant letter is assigned, keys to which the vowels [symbol] and [symbol] related to the vowel [symbol] are assigned, around the vowel [symbol] key; arranging, when the object moves from the vowel [symbol] key to the vowel [symbol] or [symbol] key without losing the contact of the vowel [symbol] key, keys to which the vowels, [symbol] and [symbol] related to the vowel [symbol] assigned, around the vowel [symbol] key, or keys to which the vowels, [symbol] and [symbol] related to the vowel [symbol] assigned, around the vowel [symbol] key; arranging, when the object moves from the key, to which the compound consonant is assigned, to the vowel [symbol] key, while pressing the key to which the compound consonant is assigned, keys to which the vowels, [symbol] and [symbol] related to the vowel [symbol] are assigned, around the vowel [symbol] key; arranging, when the object moves from the vowel [symbol] key to the vowel [symbol] or [symbol] key without losing the contact of the vowel [symbol] key, keys to which the vowels [symbol] and [symbol] related to the vowel [symbol] are assigned, around the vowel [symbol] key, or keys, to which the vowels [symbol] and [symbol] keys, related to the vowel [symbol] key, are assigned, around the vowel [symbol] key; and inputting, when the object moves from one key to another while press ing the key to which the representative letter and the fifth related letter are assigned, and then releases the pressing operation, a Korean syllable combined with corresponding consonants and vowels.

Preferably, the method may further include: assigning a space function to the ‘#’ key; and inputting, when the pressing operation to the ‘#’ key is released, a space to the mobile device.

Preferably, themethodmay further include: arranging,when the object moves from the key to which the representative letter is assigned to a key to which a corresponding number is assigned, while pressing the key to which the representative letter is assigned, keys to which symbols are assigned, around the key to which a corresponding number is assigned, wherein the symbols includes ‘!’, ‘48 ’, and ‘(‘and ’)’; and inputting, when the object moves from the key to which a corresponding number is assigned to a key to which one of the symbols is assigned or to which another number is assigned and then releases the pressing operation, a corresponding number or symbol to the mobile device.

Preferably, in an English alphabet input mode, the method may further include: grouping the 26 English letters to {a, b, c}, {d, e, f}, {g, h, j}, {j, k, l}, {m, n, o}, {p, q, r, s}, {t, u, v} and {w, x, y, z} and assigning them to eight number keys, respectively, according to an international standard; arranging, when a number key is pressed, keys to which English letters, a number and symbols, assigned to the pressed number key, are allocated, around the pressed number key; and inputting, when the object moves from the number key to a key to which one of the English letters, numbers, and symbols is allocated, while pressing the number key, and then releases the pressing operation, a corresponding letter where the pressing operation has been released to the mobile device.

### BRIEF DESCRIPTION OF THE DRAWINGS

The features and advantages of the invention will become more apparent from the following detailed description in conjunction with the accompanying drawings, in which:

FIG. 1 is a view illustrating the arrangement of Hangeul keys adapted to a conventional Cheon-Ji-In input method;

FIG. 2 is a view illustrating the arrangement of Hangeul keys adapted to a conventional EZ Hangeul input method;

FIG. 3 is a view illustrating the arrangement of Hangeul keys adapted to a method for inputting key-extension letters according to an embodiment of the invention;

FIG. 4 is a view that describes a process of inputting a Korean sentence [symbol] , according to an embodiment of the present invention;

FIG. 5 is a view illustrating the arrangement of English keys adapted to a method for inputting key-extension letters according to an embodiment of the present invention; and

FIG. 6 is a view that describes a process of inputting an English word “on”, according to an embodiment of the present invention.

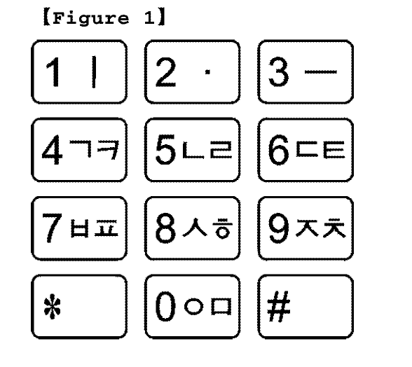

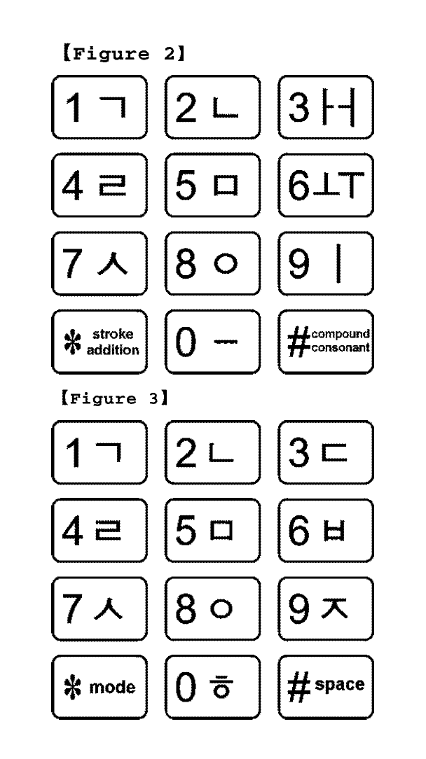

### DETAILED DESCRIPTION OF EXEMPLARY EMBODIMENTS Hereinafter, exemplary embodiments of the invention are described in detail with reference to the accompanying drawings.

FIG. 3 is a view illustrating the arrangement of Hangeul keys adapted to a method for inputting key-extension letters according to an embodiment of the invention.

As shown in FIG. 3, in order to input Hangeul to the mobile device, the keys are set as follows: 10 of the 19 consonants, [symbol] [symbol] [symbol] [symbol] and [symbol] as representative consonants, are assigned to 10 number keys, respectively; a mode switch function is assigned to the * key to switch an input mode where numbers, symbols or other foreign language alphabet, for example, English, are input to the mobile device; and a space function is assigned to the ‘#’ key. It should be understood that the representative consonants assigned to the 10 keys are not limited to the 10 consonants listed above. It should also be understood that the number of representative consonants is not limited to 10.

Pressing one of 10 consonant keys shows new letters related to the pressed consonant in the top, bottom, right and left keys around the pressed consonant key: a number appears at the upper key; some consonants related to the pressed consonant, [symbol] [symbol] and [symbol] appear at the left key; the vowel [symbol] appears at the lower key; and the vowel [symbol] appears at the right key. Each key can be operated as follows.

Step 1. When an object presses a corresponding consonant key and is then released therefrom without moving from the pressed key to the other keys that have newly appeared, a corresponding consonant assigned to the pressed key is input to the mobile device.

Step 2. When an object moves from a corresponding consonant key to the upper key to which a number is assigned, while pressing the corresponding consonant key, and then releases the number key, the corresponding number is input to the mobile device.

Step 3. When an object moves from a corresponding consonant key to the lower key to which the vowel [symbol] is assigned, while pressing the corresponding consonant key, some vowels, [symbol] and [symbol] related to the vowel [symbol] appear at the lower key. When the object releases the pressing operation from the vowel [symbol] key, a syllable (e.g., [symbol] etc.) is formed by combining a corresponding consonant with the vowel [symbol] and then input to the mobile device.

Meanwhile, when the object moves from the vowel [symbol] key to the vowel [symbol] or [symbol] key, without releasing the pressing operation from the vowel [symbol] key, some vowels, [symbol] etc., related to the vowel [symbol] and some vowels, [symbol] etc., related to [symbol] , newly appear at the lower key. When the object releases the pressing operation from the vowel [symbol] or [symbol] key, a syllable (e.g., [symbol] [symbol] etc.) is formed by combining a corresponding consonant with the vowel [symbol] and then input to the mobile device.

On the other hand, when the object moves from the vowel [symbol] or [symbol] key to the vowel [symbol] or [symbol] key or vowel [symbol] [symbol] or [symbol] key, without releasing the pressing operation from the vowel [symbol] or [symbol] key, and then releases the pressing operation from the vowel [symbol] or [symbol] key or vowel [symbol] or [symbol] key, a syllable (e.g., [symbol] [symbol] etc.) is formed by combining a corresponding consonant with the vowel, [symbol] [symbol] or [symbol] and then input to the mobile device.

Step 4. When an object moves from a corresponding consonant key to the right key to which the vowel [symbol] is assigned, while pressing the corresponding consonant key, some vowels, [symbol] and [symbol] related to the vowel [symbol] appear at the right key. When the object releases the pressing operation from the vowel [symbol] key, a syllable (e.g. , [symbol] etc.) is formed by combining a corresponding consonant with the vowel [symbol] and then input to the mobile device.

Meanwhile, when the object moves from the vowel [symbol] key to the vowel [symbol] or [symbol] key, without releasing the pressing operation from the vowel [symbol] key, some vowels [symbol] [symbol] etc. related to the vowel [symbol] or some vowels [symbol] [symbol] etc . related to related to the vowel [symbol] newly appear. When the object releases the pressing operation from the vowel [symbol] or [symbol] key, a syllable (e.g., [symbol] etc.) is formed by combining a corresponding consonant with the vowel [symbol] or [symbol] and then input to the mobile device.

On the other hand, when the object moves from the vowel [symbol] or [symbol] key to the vowel [symbol] and [symbol] keys or vowel [symbol] and [symbol] keys, without releasing the press ing operation from the vowel [symbol] or [symbol] key, and then releases the pressing operation from the vowel [symbol] and [symbol] keys or vowel [symbol] and [symbol] keys, a syllable (e.g., [symbol] [symbol] [symbol] etc.) is formed by combining a corresponding consonant with the vowel [symbol] [symbol] or [symbol] and then input to the mobile device.

Step 5. When an object moves from a corresponding consonant key to the left key to which the voiced consonants [symbol] [symbol] etc. are assigned (compound consonant [symbol] appears when there is the consonant [symbol] ), while pressing the corresponding consonant key, additional compound consonants of a corresponding consonant may newly appear. It will be noted that pressing a consonant [symbol] or [symbol] key makes the voiced consonant [symbol] or [symbol] key and the compound consonant [symbol] or [symbol] key appear. According to embodiments, the voiced consonant key can be arranged in such away that: a compound consonant key of a corresponding consonant appears at the top; the vowel [symbol] key appears at the bottom; and the vowel [symbol] key appears at the right.

When the object releases the pressing operation from a corresponding consonant without moving to a voiced consonant key, the corresponding consonant is input. When the object moves from a corresponding voiced consonant key to the vowel [symbol] key at the bottom or the vowel [symbol] key at the right, while pressing the corresponding voiced consonant key, and performs Steps 3 and 4 described above, a syllable is formed by combining the corresponding voiced consonant with the corresponding vowel and then input to the mobile device.

When the object moves from a corresponding voiced consonant key to the compound consonant [symbol] or [symbol] key at the top, while pressing the corresponding voiced consonant key, the vowel [symbol] and [symbol] keys appear at the bottom and right, respectively. When the object releases the pressing operation from the compound consonant key, a corresponding compound consonant is input. On the contrary, when the object moves from a corresponding compound consonant key to the vowel [symbol] key at the bottom or the vowel [symbol] key at the right and then, and performs Steps 3 and 4 described above, a syllable is formed by combining the corresponding compound consonant with the corresponding vowel and then input to the mobile device.

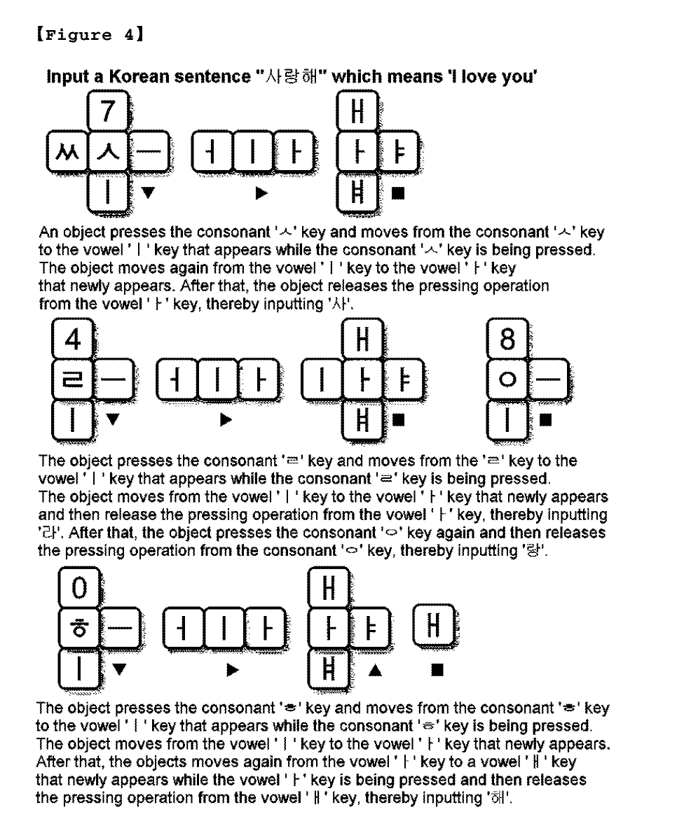

FIG. 4 is a view that describes a process of inputting a Korean sentence [symbol] , according to an embodiment of the present invention.

As shown in FIG. 4, a Korean sentence [symbol] which means ‘I love you’ is input to the mobile device as follows:

(1) Input the syllable

[symbol]

An object presses the consonant [symbol] key and moves from the consonant [symbol] key to the vowel key [symbol] that appears while the consonant [symbol] key is being pressed. The object moves again from the vowel [symbol] key to the vowel [symbol] key that newly appears. After that, the object releases the pressing operation from the vowel [symbol] key, thereby inputting

[symbol]

(2) Input the syllable

[symbol]

The object presses the consonant [symbol] key and moves from the [symbol] key to the vowel [symbol] key that appears while the consonant [symbol] key is being pressed. The object moves from the vowel [symbol] key to the vowel [symbol] key that newly appears and then releases the pressing operation from the vowel [symbol] key, thereby inputting [symbol] After that, the object presses the consonant [symbol] key again and then releases the pressing operation from the consonant [symbol] key, thereby inputting

[symbol]

(3) Input the syllable

[symbol]

The object presses the consonant [symbol] key and moves from the consonant [symbol] key to the vowel [symbol] key that appears while the consonant [symbol] key is being pressed. The object moves from the vowel [symbol] key to the vowel [symbol] key that newly appears. After that, the objects moves again from the vowel [symbol] key to a vowel [symbol] key that newly appears while the vowel [symbol] key is being pressed and then releases the pressing operation from the vowel [symbol] key, thereby inputting

[symbol]

As described above, when a Hangeul syllable has initial and medial position letters but does not have a final position letter, it can be input to the mobile device as the object contacts once on the touch screen and moves to corresponding keys without losing the contact. When a Hangeul syllable has initial, medial, and final position letters, only one additional touch is required to input the final position letter. This reduces the number of key operations, compared with conventional Korean letter input methods. In addition, this method according to the invention can also prevent the consonant collision phenomenon and make it simple to input Hangeul to the mobile device. Therefore, this method can allow users who know only Hangeul to easily input it to the mobile device.

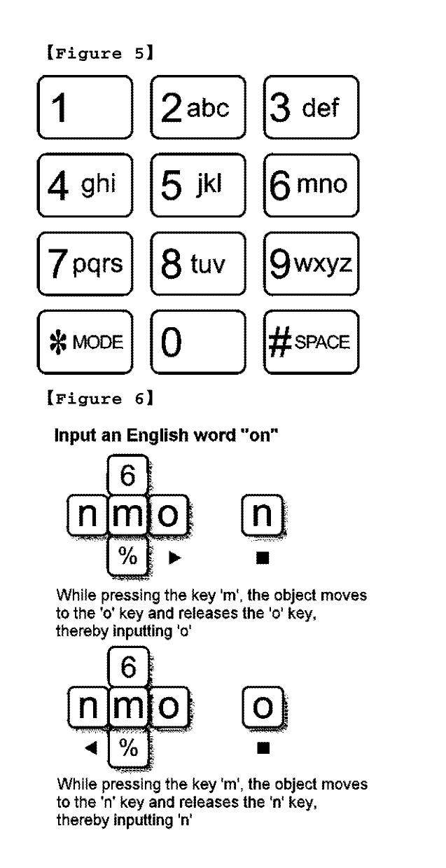

The method for inputting key-extension letters according to the invention can also allow for the input of English letters and is described in detail with reference to FIGS. 5 and 6.

FIG. 5 is a view illustrating the arrangement of English keys adapted to a method for inputting key-extension letters according to an embodiment of the present invention.

As shown in FIG. 5, based on an international standard 12-key keypad, the 26 letters of the English alphabet are assigned to eight number keys, 2 to 9, by 3˜4 letters. For example, {a, b, c}, {d, e, f}, {g, h, j}, {j, k, l}, {m, n, o}, {p, q, r, s}, {t, u, v} and {w, x, y, z} are assigned to 2 to 9 number keys, respectively.

FIG. 6 is a view that describes a process of inputting an English word “on”, according to an embodiment of the present invention.

As shown in FIG. 6, pressing one of the eight number keys, to which the English letters are assigned, shows the letters, number, symbols, etc., on the pressed key, to which the letters, number, symbols, etc., were assigned, and on the top, bottom, right and left keys around the pressed key. When an object presses a corresponding key and is then released therefrom without moving from the pressed key to the other keys that newly appear, a corresponding letter assigned to the pressed key is input to the mobile device. On the contrary, when the object moves from the pressed key to the other keys that have newly appeared and is then released from the newly shown key, a corresponding letter or number is input to the mobile device. This can resolve the problems of the conventional letter input methods where the user must wait for a certain period of time until the cursor moves to the next position when he/she repeatedly inputs the same letter or successively another letter assigned to the same key, or the user must operate a cursor movement key before the certain period of time when the cursor moves to the next position has elapsed. In addition, the method of the invention can also resolve the inconvenience where an input mode mus t be switched to input numbers, symbols, etc. to the mobile device.

The method for inputting key-extension letters, according to the invention, can maximize the input efficiency by reducing the movement distance of an object on the touch screen and the number of key operations, compared with Cheon-Ji-In, EZ Hangeul, and other conventional letter input methods, etc., thereby allowing users to easily and rapidly input Hangeul, English letters, numbers, symbols, etc. to the mobile device.

The following table 1 shows the comparison among the method for inputting key-extension letters according to the invention (termed ‘Extension’), conventional Cheon-Ji-In, and conventional EZ Hangeul, with respect to the number of keys used when each of the Hangeul vowels and consonants is input to the mobile device.

TABLE 1

| | | No. of used keys | | | | |
|---|---|---|---|---|---|---|
| | | 1 | 2 | 3 | 4 | 5 |
| Cheon-Ji-In | Vowels | 19 | — | — | — | — |
| | Consonants | 2 | 10 | 5 | 3 | 1 |
| EZ Hangeul | Vowels | 6 | 9 | 4 | — | — |
| | Consonants | 6 | 11 | 4 | — | — |
| Extension | No discrimination of | 19 + 21 | — | — | — | — |
| | Vowels/Consonants | | — | — | — | — |

As described in table 1, in order to input one syllable in Korean, conventional Cheon-Ji-In and EZ Hangeul letter input methods require at least two or more keys to be used. In particular, since few Hangeul vowels and consonants can be input by using one or two keys, conventional Hangeul letter input methods have a lower input efficiency in most cases.

In Cheon-Ji-In, the number of Hangeul consonants input by using one key is 19. That is, 100% of Hangeul consonants can be input by one key. This causes the consonant collis ion phenomenon. Cheon-Ji- In has a very low input efficiency when inputting vowels. That is, Cheon-Ji-In has only two keys to which two vowels are assigned respectively, and allows for the input of the two vowels as they are using the two keys. Of 40 letters comprising of Hangeul vowels and consonants, Cheon-Ji-In can allow for the input of 21 letters, as it is, by using one key, which is 52.5%.

Likewise, of 40 letters comprising of Hangeul vowels and consonants, EZ Hangeul can allow for the input of 12 letters, as it is, by using one key, which is about 30%.

Meanwhile, the method for inputting key-extension letters according to the invention can allow for the direct input of all Hangeul syllables without the final position letter via one key, thereby increasing the input efficiency. For example, in order to input the Korean national anthem,

Cheon-Ji-In, EZ Hangeul, and Extension operate the number of keys as follows.

(1) Cheon-Ji-In: 177 (the average number of used keys per letter: 3.4)

(2) EZ Hangeul: 151 (the average number of used keys per letter: 2.9)

(3) Extension: 71 (the average number of used keys per letter : 1.36)

As described above, it will be appreciated that the method for inputting key-extension letters according to the invention has a high input efficiency compared with conventional Hangeul input methods. In particular, the number of keys, used by Cheon-Ji-In and EZ Hangeul letter input methods, is acquired in such a way that, when the same key is successively pressed twice or more to input the same letter, the number of pressing actions is counted as one time. On the contrary, if the number of actions is counted as the number of actions successively performed by pressing the same key twice or more, the number of keys, used by Cheon-Ji-In and EZ Hangeul letter input methods, further increases and differs more from that of the method for inputting key-extension letters according to the invention. In addition, Cheon-Ji-In and EZ Hangeul letter input methods also count the number of actions to operate a cursor movement key due to the consonant col lision phenomenon and add it to the number of used keys. In that case, the number of used keys increases between the Cheon-Ji-In or EZ Hangeul letter input method and the method for inputting key-extension letters according to the invention.

Like the input of Hangeul, the Cheon-Ji-In and EZ Hangeul letter input methods cause a letter collision phenomenon when the same English letter is successively input or when one English letter is input and then another English letter, assigned to the key to which one English letter is assigned, is input successively after inputting one English letter. For example, in order to input the word ‘on’, the user presses the 6 key three times, to which ‘m, n, and o’ are assigned, thereby inputting ‘o’. After that, the user waits a certain period of time until the cursor moves to the next position or presses a cursor movement key. Next, the user presses again the 6 key twice, thereby inputting ‘n’.

On the contrary, the method for inputting key-extension letters according to the invention can input the word ‘on’ as follows. When the user presses the 6 key to which ‘m, n, and o’ are assigned, the m, n, and o keys appear. The user moves his/her finger, for example, to the ‘o’ key without losing the first contact of the 6 key and then removes it from the o key, thereby inputting ‘o’. After that, the user presses the 6 key again without waiting for a certain period of time until the cursor moves to the next position or without operating the cursor movement key. The m, n, and o keys appear. In that case, the user moves his/her finger to the n key without losing the second contact of the 6 key and then removes it from the n key, thereby inputting ‘n’. Therefore, the method for inputting key-extension letters according to the invention can input English letters without a letter collision phenomenon, which increases the English letter input efficiency. In addition, the method according to the invention can successively input numbers or symbols together with English letters, which increases the input efficiency.

As described above, the method for inputting key-extension letters on a touch screen, according to the invention, can repeatedly generate, when a particular key is pressed, keys related to a corresponding key and can input, when a pressing operation is released from the generated key, a letter at a corresponding position, when letters, such as Hangeul (i.e., Korean alphabet), are input on a touch screen of a mobile device (e.g. mobile phone, navigation system, PDA, PMP, etc.) or a stationary communication device. Therefore, the letter input method can resolve the conventional problems where a collision phenomenon occurs when consonants are input on the touch screen or letters are complicatedly input by combining consonants and vowels. The letter input method can also allow users to easily and rapidly input Hangeul, English, Japanese, etc. as well as numbers, symbols, etc., by using the minimum number of keys or pressing the keys the minimum number of times.

Although exemplary embodiments of the invention have been described in detail hereinabove, it should be understood that many variations and modifications of the basic inventive concept herein described, which may appear to those skilled in the art, will still fall within the spirit and scope of the exemplary embodiments of the invention as defined in the appended claims.

What is claimed is:

1. A method for inputting key-extension letters on a touch screen installed to a mobile device or a stationary communication device, the method comprising:
(1) allocating representative letters to 12 keys, including the number, * and # keys, or to a corresponding number of keys, respectively;
(2) arranging, if one of the keys is pressed, keys to which numbers, consonants, vowels, letters, or symbols are allocated, around the pressed key, wherein the numbers, consonants, vowels, letters, or symbols (hereinafter called ‘first related letters’) are related to a representative letter assigned to the pressed key;
(3) inputting, when an object (a user's finger, etc.) moves from the pressed key to other keys to which the first related letters are assigned without losing the contact of the pressed key and then releases the pressing operation from the pressed key or a corresponding key, the representative letter or one of the first related letters assigned to the corresponding key to the touch screen; and
(4) arranging, when the key to which one of the first related letters is assigned is pressed, keys to which second related letters, related to a first related letter assigned to the pressed first related-letter key, are assigned, around the first related letter key.

2. The method according to claim 1, wherein:
the representative letters are Hangeul (the Korean alphabet); and
the method, in a Hangeul input mode, further comprises:
assigning 10 representative letters, [symbol] [symbol] [symbol] [symbol] and [symbol] to 10 number keys;
arranging, when a key to which one of the representative letters is assigned is pressed, keys to which third related letters are assigned, around the pressed representative letter key, wherein the third related letters include the number assigned to the pressed key, voiced consonants of the representative letter assigned to the pressed key, and the vowels [symbol] and [symbol]
arranging, when the object moves from the key, to which the representative letter is assigned, to the vowel [symbol] key, while pressing the key to which the representative letter is assigned, keys to which the vowels [symbol] and [symbol] related to the vowel [symbol] are assigned, around the vowel [symbol] key;
arranging, when the object moves from the vowel [symbol] key to the vowel [symbol] or [symbol] key without losing the contact of the vowel [symbol] key, keys to which the vowels, [symbol] and [symbol] related to the vowel [symbol] , assigned, around the vowel [symbol] key, or keys to which the vowels, [symbol] and [symbol] related to the vowel [symbol] assigned, around the vowel [symbol] key;
arranging, when the object moves from the key, to which the representative letter is assigned, to the vowel [symbol] key, while pressing the key to which the representative letter is assigned, keys to which the vowels, [symbol] and [symbol] related to the vowel [symbol] are assigned, around the vowel [symbol] key;
arranging, when the object moves from the vowel [symbol] key to the vowel [symbol] or [symbol] key without losing the contact of the vowel [symbol] key, keys to which the vowel [symbol] and [symbol] related to the vowel [symbol] are assigned, around the vowel [symbol] key, or keys, to which the vowels [symbol] and [symbol] keys, related to the vowel [symbol] key, are assigned, around the vowel [symbol] key; and
inputting, when the object moves from one key to another while pressing the key to which the representative letter and the third related letter are assigned, and then releases the pressing operation, a Korean syllable combined with corresponding consonants and vowels.

3. The method according to claim 2, wherein:
the representative letters are Hangeul (the Korean alphabet); and
the method further comprises:
arranging, when the object moves from a key, to which one of the representative letters is assigned, to the key to which the voiced consonant is assigned, while pressing the key to which the representative letter is assigned, keys to which fourth related letters are assigned, around the key to which the voiced consonant is assigned, wherein the fourth related letters include compound consonants related to the voiced consonant and the vowels [symbol] and [symbol]
arranging, when the object moves from the key, to which the voiced consonant is assigned, to the vowel [symbol] key, while pressing the key to which the voiced consonant letter is assigned, keys to which the vowels [symbol] and [symbol] related to the vowel [symbol] are assigned, around the vowel [symbol] key;
arranging, when the object moves from the vowel [symbol] key to the vowel [symbol] or [symbol] key without losing the contact of the vowel [symbol] key, keys to which the vowels, [symbol] and [symbol] related to the vowel [symbol] , assigned, around the vowel [symbol] key, or keys to which the vowels, [symbol] and [symbol] related to the vowel [symbol] assigned, around the vowel [symbol] key;
arranging, when the object moves from the key, to which the voiced consonant is assigned, to the vowel [symbol] key, while pressing the key to which the voiced consonant is assigned, keys to which the vowels, [symbol] and [symbol] related to the vowel [symbol] are assigned, around the vowel [symbol] key;
arranging, when the object moves from the vowel [symbol] key to the vowel [symbol] or [symbol] key without losing the contact of the vowel [symbol] key, keys to which the vowel [symbol] and [symbol] related to the vowel [symbol] are assigned, around the vowels [symbol] key, or keys, to which the vowels [symbol] and [symbol] keys, related to the vowel [symbol] key, are assigned, around the vowel [symbol] key; and
inputting, when the object moves from one key to another while pressing the key to which the representative letter and the fourth related letter are assigned, and then releases the pressing operation, a Korean syllable combined with corresponding consonants and vowels.

4. The method according to claim 3, wherein:
the representative letters are Hangeul (the Korean alphabet); and
the method further comprises:
arranging, when the object moves from a key, to which the voiced consonant is assigned, to the key to which the compound consonant is assigned, while pressing the key to which the voiced consonant is assigned, keys to which fifth related letters are assigned, around the key to which the compound consonant is assigned, wherein the fifth related letters include the vowels [symbol] and [symbol] related to the compound consonant;
arranging, when the object moves from the key, to which the voiced consonant is assigned, to the vowel [symbol] key, while pressing the key to which the voiced consonant letter is assigned, keys to which the vowels [symbol] and [symbol] related to the vowel [symbol] are assigned, around the vowel [symbol] key;
arranging, when the object moves from the vowel [symbol] key to the vowel [symbol] or [symbol] key without losing the contact of the vowel [symbol] key, keys to which the vowels, [symbol] and [symbol] related to the vowel [symbol] assigned, around the vowel [symbol] key, or keys to which the vowels, [symbol] and [symbol] related to the vowel [symbol] assigned, around the vowel [symbol] key;
arranging, when the object moves from the key, to which the compound consonant is assigned, to the vowel [symbol] key, while pressing the key to which the compound consonant is assigned, keys to which the vowels, [symbol] and [symbol] related to the vowel [symbol] are assigned, around the vowel [symbol] key;
arranging, when the object moves from the vowel [symbol] key to the vowel [symbol] or [symbol] key without losing the contact of the vowel [symbol] key, keys to which the vowels [symbol] and [symbol] related to the vowel [symbol] are assigned, around the vowel [symbol] key, or keys, to which the vowels [symbol] and [symbol] keys, related to the vowel [symbol] key, are assigned, around the vowel [symbol] key; and
inputting, when the object moves from one key to another while pressing the key to which the representative letter and the fifth related letter are assigned, and then releases the pressing operation, a Korean syllable combined with corresponding consonants and vowels.

5. The method according to claim 1, further comprising:
assigning a space function to the # key; and
inputting, when the pressing operation to the # key is released, a space to the mobile device.

6. The method according to claim 2, further comprising:
arranging, when the object moves from the key to which the representative letter is assigned to a key to which a corresponding number is assigned, while pressing the key to which the representative letter is assigned, keys to which symbols are assigned, around the key to which a corresponding number is assigned, wherein the symbols includes ‘!’, ‘?’, ‘(’ and ‘)’; and
inputting, when the object moves from the key to which a corresponding number is assigned to a key to which one of the symbols is assigned or to which another number is assigned and then releases the pressing operation, a corresponding number or symbol to the mobile device.

7. The method according to claim 1, wherein:
the representative letters are the English alphabet; and
the method, in an English alphabet input mode, further comprises:
grouping the 26 English letters to {a, b, c}, {d, e, f}, {g, h, _{j}}, {j, k, 1}, {m, n, o}, {p, q, r, s}, {t, u, v} and {w, x, y, z} and assigning them to eight number keys , respectively, according to an international standard;
arranging, when a number key is pressed, keys to which English letters, a number and symbols, assigned to the pressed number key, are allocated, around the pressed number key; and
inputting, when the object moves from the number key to a key to which one of the English letters, numbers, and symbols is allocated, while pressing the number key, and then releases the press ing operation, a corresponding letter where the pressing operation has been released to the mobile device.
